(19) United States
(12) Patent Application Publication
(10) Pub. No.: US 2016/0084778 A1
(43) Pub. Date: Mar. 24, 2016

(54) METHOD FOR EXANIMATION OF ELEMENT IN LIVING BODY

(71) Applicant: MINERAL RESEARCH SOCIETY, Osaka-shi, Osaka (JP)

(72) Inventors: Yoshitane KOJIMA, Izumi-shi (JP); Yutaka YOSHIKAWA, Toyonaka-shi (JP); Akio ICHIMURA, Suita-shi (JP)

(73) Assignee: MINERAL RESEARCH SOCIETY, Osaka-shi, Osaka-fu (JP)

(21) Appl. No.: 14/771,173

(22) PCT Filed: Feb. 28, 2013
(86) PCT No.: PCT/JP2013/055311

§ 371 Date: Dec. 8, 2015

(51) Int. Cl. G01N 23/223; H01J 49/10

(52) U.S. Cl. CPC G01N 23/223; H01J 49/105

(57) ABSTRACT

The nutritionally and/or medically significant measured value on mineral elements contained in the body of a test subject can be detected by a hair test. The signal ratio P_{XRF}(S) of said mineral element contained in the hair of said test subject to sulfur contained therein is measured by fluorescent X-ray spectroscopy, and then is multiplied by a conversion factor F to determine the element content M_{XRF} of the mineral element in the hair. This conversion factor F is calculated according to the formula F=M_{0.ICP}/P_{0.XRF}(S), wherein P_{0XRF}(S) is a reference signal ratio of the mineral element contained in reference hair collected from a person exclusive of the test subject, and M_{0.ICP} is a reference element content of the mineral element therein as determined by inductivity coupled plasma mass spectroscopy.

### FIELD OF THE INVENTION

The present invention relates to a method of elemental analysis in a hair, and more specifically relates to a method to judge a state of health on the basis of the intake situation of essential elements and toxic elements as nutritive substances of a test subject by using of the quantitative analysis of elements in the hair. In addition, the present invention relates to an examination method of elements included within a hair by using of the fluorescence X-ray analysis device.

### BACKGROUND ART

The essential element such as calcium, iron, copper or zinc is hard to be absorbed in a digestive organ, and even if these essential elements are taken as a simple substance, they are almost exhausted without being absorbed. In addition, it is known the effect that the toxic elements become hard to be absorbed and easy to be exhausted, if the essential elements are taken adequately with good balance. It is a very important thing to measure non-destructively and simply whether the essential elements are absorbed and taken in a living body.

Through the animals and plants chain in the natural world, for example, when the harmful metal such as mercury included in a tuna with high density is taken in a human body as the toxic element by an oral intake, it is very useful for protecting simply and easily the security of appetite to measure non-destructively whether the toxic element is accumulated in a human body.

Because the quantitative determination of element done today using atomic absorption spectrometry, absorption photometry, neutron activation analysis method and inductivity coupled plasma mass spectrometry (ICP-MS) etc. has the high sensitivity as ppb (one billionth), the high facilities like clean room are needed to show enough the sensitivity. In addition, since the high techniques for complicated pretreatment and sample preparation are required, it is a weak point that the correct data can be provided only by a specific engineer.

Even more particularly, when the quantity of element is determined by various methods, since it is received the large influence by the state of the outer-shell electrons of this element such as the electric charge and the bonding state, the serious time and expense are forced for the pretreatment to keep the element to be directed in the same state usually (non-patent documents 1-3).

In recent years, an measurement method of element in a hair is developed by fluorescence X-ray analysis with the use of synchrotron radiation, and this method is disclosed in Japanese Patent 4065734 bulletin (patent document 1) and the non-patent document 4, but it is difficult to take machine time for the measurement and it is difficult to use as the measurement method of a hair of general person.

In Japanese Patent Laid-Open No. 2012-98097 bulletin (patent document 2), the fluorescence X-ray analysis device is used and the measurement about the relative value of fluorescence X-ray strength of Calcium to Sulfur (S) in the hair using one hair is reported, but it is not measured as the absolute value and it is not evaluated as the examination for the element content.

In the non-patent document 5, by means of the fluorescence X-ray analysis device it is reported that the densities of potassium and calcium in the hair of test subject are measured, where the relative value of the fluorescence X-ray strength of potassium and calcium to sulfur in one hair of the test subject is employed. In here, as well as the patent document 3, the fluorescence X-ray strength of the element in a hair is normalized by use of the fluorescence X-ray strength of sulfur in the hair. However, in here, since the fluorescence X-ray strength of the element in the hair is not converted into the absolute value of the element, it is not evaluated as the test based upon the element content.

[Patent Document 1] Japanese Patent 4065734.

[Patent Document 2] Japanese Patent Laid-Open 2012-98097.

[Non-Patent Document 1] “Advice of Hair Mineral Inspection” by Takashi Omori, Cosmo Two One Co., Ltd. (2005).

[Non-Patent Document 2]“Health Study of Zinc” by Satoshi Kondo, Japan Heath Institute Co., Ltd. (1996).

[Non-Patent Document 3] “Health Degree Understood Right Out by Hair Analysis” by Ryoji Imai, Chukei Publishing Company (1982).

[Non-Patent Document 4]“Omen and Outbreak of Breast Cancer Understood by Hair-Early Detection with Synchrotron Radiation Fluorescence X-Ray Analysis” by Junichi Chikawa, Kosaku Yamada, Toshio Akimoto, Hiroshi Sakurai, Hiroyuki Yasui, Hitoshi Yamamoto, Masaaki Ebara and Hiroyuki Fukuda, Magazine “Synchrotron”, Vol. 18, pp 84-91 (2005).

[Non-Patent Document 5] “Hair Test by Fluorescence X-Ray Analysis” by Shigeji Kobayashi, Masami Yanagida, Takatoshi Higashi, Magazine “Department of Science and Engineering Collection Reports of Saga University”, Vol. 35, pp 1-6 (2006).

### DISCLOSURE OF THE INVENTION

### Problems to be Solved by the Invention

In the measurement of element in a hair due to the fluorescence X-ray analysis with the use of synchrotron radiation, it is difficult to take machine time for the measurement, and it is difficult to use as a measurement method of a hair of general persons. On the other hand, the qualitative examination method by the hair has been known for the general-purpose fluorescence X-ray analysis device of which energy is not so strong, but the trial to get the quantitative data with high precision has not been done. In the patent document 2 and the non-patent document 5, the semi-quantitative measurement of element was tried for the fluorescence X-ray analysis of hair, where the fluorescence X-ray strength from sulfur in the hair is considered to be a standard, but such a measurement data could not be employed to demand a correlation with the quantitative element measurement data which could be measured from blood.

By use of the other methods, for example, the quantitative analysis of element in the hair has been done by the atomic absorption spectrophotometry, ICP-MS method, and so on. In order to perform those measurements, hairs are destroyed by acid or heat, and then they must be treated to a water solution sample, and by way of example only, since a large quantity of hairs like 0.2 g (150 hairs with 3 cm in length from its root) are used, it is difficult to wash, and since the hair being easy to wake up static electricity is easy to be polluted by metal ions, the wrong inspection data are easy to be provided by the pollution. In addition, because the sample is consumed by its damage, it is impossible to rewash and reexamine for re-confirmation of sample. Besides, since the sensitivity of the measuring device is high up to the level of ppb (one billionth), the clean room etc. are needed to avoid pollution.

Since the quantitative determination of element using atomic absorption spectrometry, absorption photometry, neutron activation analysis method and inductivity coupled plasma mass spectrometry (ICP-MS) etc. needs high techniques for complicated preprocessing of sample and sample adjustment, there was a weak point that only a specific engineer can get correct data. Besides, when the quantitative determination of element is done by said analysis method, because it receives the large influence by the state of the outer-shell electrons of this element such as the electric charge and the bonding state, the serious time and expense are forced to the preprocessing to put the target element in usual at the same state. In addition, the clean room etc. which are expensive facilities are needed to avoid pollution.

### Means to Solve the Problems

The present invention was done to solve the above problems. Therefore, the first form of the present invention is a method for examination of element in living body comprising the steps of measuring a signal ratio P_{XRF}(S) of a mineral element contained in a hair of a test subject to sulfur contained in said hair by a fluorescence X-ray analysis, and in order to calculate an element content M_{XRF} of said mineral element from said signal ratio P_{XRF}(S), multiplying said signal ratio P_{XRF}(S) by a conversion factor F used in said calculation.

The second form of the present invention is the method for examination of element in living body according to claim 1, wherein said conversion factor F is derived from the steps of measuring a reference signal ratio P_{0.XRF}(S) of said mineral element contained in a reference hair collected from a person exclusive of said test subject to said sulfur contained in said reference hair by said fluorescence X-ray analysis, measuring a reference element content M_{0.ICP} of said mineral element by an inductivity coupled plasma mass pectrometry, and calculating said conversion factor F from a formula of F=M_{0.ICP}/P_{0.XRF}(S).

The third form of the present invention is the method for examination of element in living body according to claim 1 or 2, wherein said fluorescence X-ray analysis is performed by detecting fluorescence X-ray occurring through irradiating of X-rays to said hair.

The fourth form of the present invention is the method for examination of element in living body according to claim 1 or 2, wherein said fluorescence X-ray analysis is performed by the steps of dissolving said hair in a solvent and detecting fluorescence X-ray occurring through irradiating of X-rays to said solution.

### Effects of the Invention

According to the first form of the present invention, because said signal ratio P_{XRF}(S) is multiplied by the conversion factor F used for calculation to derive an element content M_{XRF} of said mineral element contained in said hair, this element content M_{XRF} can be obtained as weight ratio or mole concentration, and the analytical results appropriate for physiological activity than the conventional fluorescence X-ray analysis can be got. In the conventional fluorescence X-ray analysis, the signal ratio determined for the signal of sulfur as a standard was provided, but by means of this, a number based on the concrete mass such as, for example, the weight ratio could not be obtained. On the other hand, the concentration of a mineral element found from other parts (for example, blood) in a body was a weight ratio or a mole ratio. Therefore, it was difficult to compare these concentration with data by the conventional fluorescence X-ray analysis. According to the present invention, because it is possible to obtain this signal ratio as the concentration based upon of mass or mole number of mineral elements, the physiologically useful data can be provided. Besides, since in the fluorescence X-ray analysis method, for example, being different from the inductivity coupled plasma mass analysis, it is possible to analyze by means of one hair without making dissolve it, by using a very small amount of hair and analyzing them non-destructively with the present invention, it is possible to obtain the weight ratio or the mole ratio of mineral elements.

In the fluorescence X-ray analysis of the present invention, sulfur is used as a standard. Sulfur is included about 5% (50,000 ppm) in a hair as cysteine which is an amino acid and it is necessary for sulfur bond (—S—S—) to get strength of a hair. Therefore, because as for the sulfur concentration in a hair, there is not approximately differences between individuals, and it is not almost that it is influenced by the state of health, it is most suitable as a standard.

In the present invention, as the determination method transforming the data by the fluorescence X-ray analysis to the element content of mineral element, it is most desirable the determination using the reference hair due to the second form explained later in details. However, even if a standard hair is not employed, when the fluorescence X-ray analysis is done for a normal solution containing mineral element and sulfur and it is used a calibration curve being a graph made between the obtained signal ratio and the concentration or mass of mineral element, it is possible to get the conversion factor F from this calibration curve.

As the mineral element measurable by the present invention, any kind of element is preferable as far as one being analyzable by the fluorescence X-ray analysis, and it is possible to analyze in principle for the elements of which the atomic number is higher than sodium. More preferably, it is also an element that the inductivity coupled plasma mass analysis is possible. Most preferably, it is an element that is a nutritive mineral necessary in the human body. For purposes of example, there is enumerated an element such as calcium, iron, zinc, copper, magnesium, cobalt, manganese, molybdenum, selenium and iodine. In addition, a mineral as the analysis object may be toxic for the human body, and in this case a pollution state in the body can be observed. Lead, arsenic, mercury, nickel, cesium are enumerated as the toxic minerals.

According to the second form of the present invention, in derivation of said conversion factor F, a reference signal ratio P_{0.XRF}(S) of said mineral element contained in a reference hair collected from a person exclusive of said test subject to said sulfur contained in said reference hair is measured, a reference element content M_{0.ICP} of said mineral element contained in said reference hair by an inductivity coupled plasma mass spectrometry is measured, and since after these measurements said conversion factor F is derived from a formula of F=M_{0.ICP}/P_{0.XRF}(S), it is possible to measure the concentration of mineral contained in this reference hair precisely with the inductivity coupled plasma mass spectrometry and to derive the conversion factor F based upon this concentration. Therefore, it is possible to normalize the data of fluorescence X-ray analysis on the basis of the typical mineral concentration contained in the hair of the human body, and it is possible to connect to the measurement of the precise mineral concentration (element content) in the hair of the test subject.

In order to obtain the reference element content M_{0.ICP} of the reference hair by the inductivity coupled plasma mass spectrometry, it is necessary to perform the destructive sample formation and to employ comparatively a large quantity of hairs (about 0.2 g), but the reliable conversion factor F can be obtained by measuring of the reference element content only a few times, and it is possible to perform a large number of analyses with use of this conversion factor F.

As the reference test subject in the present form, the health person that does not have a disease is desirable as possible. However, even if it is not a healthy body, since the precise mineral concentration can be obtained by the inductivity coupled plasma mass analysis, and it does not interfere for a standard. In addition, to minimize the errors caused by fluctuation of washing etc., the number of reference test subjects is preferable so that there is much.

According to the third form of the present invention, as said fluorescence X-ray analysis is performed by detecting fluorescence X-ray occurring through irradiating of X-rays to said hair, it is possible to analyze non-destructively by use of only one hair. Therefore, it is hard to receive the influence of pollution by dissolution of hairs. In addition, because a particular part of a hair (the neighborhood of root, for example) can be measured selectively, by means of one hair, a change of the mineral concentration depending upon a measurement region can be measured and it can be applied to a forensic use.

According to the fourth form of the present invention, because said hair is dissolved in a solvent and said fluorescence X-ray analysis is performed by detecting the fluorescence X-ray occurring through irradiating of X-rays to said solution, the average element content in the whole hair can be obtained, so that it is possible to compare strictly with the inductivity coupled plasma mass analysis for the same hair sample.

### BRIEF DESCRIPTION OF THE DRAWINGS

FIG. 1 is a bar graph showing a calcium content and its standard deviation value in a hair of a test subject in example 2.

FIG. 2 is a bar graph showing an iron content and its standard deviation value in a hair of a test subject in example 2.

FIG. 3 is a bar graph showing a copper content and its standard deviation value in a hair of a test subject in example 2.

FIG. 4 is a bar graph showing a zinc content and its standard deviation value in a hair of a test subject in example 2.

FIG. 5 is a calibration curve of a reference signal ratio and a dropping amount of a normal solution containing calcium in example 4.

FIG. 6 is a calibration curve of a reference signal ratio and a dropping amount of a normal solution containing iron in example 4.

FIG. 7 is a calibration curve of a reference signal ratio and a dropping amount of a normal solution containing copper in example 4.

FIG. 8 is a calibration curve of a reference signal ratio and a dropping amount of a normal solution containing zinc in example 4.

FIG. 9 is a calibration curve of a reference signal ratio and a dropping amount of a normal solution containing arsenic in example 4.

FIG. 10 is a calibration curve of a reference signal ratio and a dropping amount of a normal solution containing cadmium in example 4.

FIG. 11 is a calibration curve of a reference signal ratio and a dropping amount of a normal solution containing mercury in example 4.

FIG. 12 is a calibration curve of a reference signal ratio and a dropping amount of a normal solution containing lead in example 4.

FIG. 13 is a calibration curve of a reference signal ratio and a dropping amount of a normal solution containing titanium in example 4.

FIG. 14 is a calibration curve of a reference signal ratio and a dropping amount of a normal solution containing cesium in example 4.

FIG. 15 is a calibration curve of a reference signal ratio of a normal solution containing calcium and a calcium concentration in the corresponding hair in example 5.

### BEST MODE FOR CARRYING OUT THE INVENTION

### Example 1

### Direct Fluorescence X-Ray Analysis of a Hair

In the present example, calcium (Ca), copper (Cu), zinc (Zn) and lead (Pb) as the mineral elements are measured.

[1] Hair as reference: hairs from their root portions of about 0.2 g (about 150 hairs of 3 cm in length from its root) are collected from each of three persons (called “reference test subject” hereinafter) exclusive of a test subject who is a person to be examined. These hairs are named “reference hair” as follows.

(a) Fluorescence X-ray analysis: one hair is set in the fluorescence X-ray analysis device and the X-rays originated from Mo-Kα or Cu-Kα are irradiated, so that the fluorescence X-ray spectrum is obtained by measuring the fluorescence X-ray generated from it. This spectrum is normalized by assuming an area of a peak originated from sulfur “1”, and then an area of a peak originated from each mineral element is measured. This normalized peak area is defined as the reference signal ratio P_{0.XRF}(S). (Instead of being normalized on a peak area, it is preferable to normalize a peak height.)

(b) ICP-MS analysis after weighing the reference hair (about 0.2 g), it is dissolved in concentrated nitric acid of about 3 mL and it is assumed 10 mL by adding water. In addition, in regard to each of mineral metals, a plurality of standard solutions with different concentration are prepared, so that by performing ICP-MS analysis, the calibration curve is made based upon the obtained data. ICP-MS analysis is done for a solution of reference hair, and by comparing the measured value obtained for each mineral element with said calibration curve, the mineral concentration in the solution is derived. From this concentration and the weight of reference hair weighed in advance, the element content of mineral element contained in the reference hair is calculated as a ppm value of weight/weight-ratio and is assumed the reference element content M_{0.ICP}. These numerical values are summarized in Table 1.

TABLE 1
Direct Determination of Conversion Factor F of Reference Hair by
Fluorescent X-ray Spectroscopy

| Reference | | Mineral | | | |
|---|---|---|---|---|---|
| Test Subject | | Calcium | Copper | Zinc | Lead |
| 1 | Reference Signal Ratio | 0.77 | 0.35 | 1.09 | 0.06 |
| | Reference Content of | 930 | 9 | 79.8 | 1.3 |
| | Element (ppm) | | | | |
| | Conversion Factor (ppm) | 1204 | 25.7 | 73.2 | 22 |
| 2 | Reference Signal Ratio | 0.27 | 0.54 | 0.76 | 0.03 |
| | Reference Content of | 345 | 23.5 | 34.5 | 0.7 |
| | Element (ppm) | | | | |
| | Conversion Factor (ppm) | 1278 | 43.5 | 45.4 | 23 |
| 3 | Reference Signal Ratio | 0.54 | 0.4 | 1.03 | 0.06 |
| | Reference Content of | 758 | 13.8 | 74.6 | 1.1 |
| | Element (ppm) | | | | |
| | Conversion Factor (ppm) | 1404 | 34.5 | 72.4 | 18 |
| | Average of Conversion | 1300 | 35 | 64 | 21 |
| | Factor | | | | |

With regard to each of minerals targeted in Table 1, the standard value of reference signal ratio P_{0.XRF}(S) and the standard value of reference element content M_{0.ICP} for said three persons are calculated, and after that, the conversion factor F is calculated by the equation (1).

F=M_{0.ICP}/P_{0.XRF}(S) (1)

[2] Hair of test subject: from each of five test subjects, one hair of the forehead with 3 cm in length from its root portion is collected. One hair is set in the fluorescence X-ray analysis device and the X-rays originated from Mo-Kα or Cu-Kα are irradiated, so that the fluorescence X-ray spectrum is obtained by measuring the fluorescence X-ray generated from it. This spectrum is normalized by assuming an area of a peak originated from sulfur “1”, and then an area of a peak originated from each mineral element is measured. This normalized peak area is defined as the signal ratio P_{XRF}(S). These signal ratio P_{XRF}(S) are summarized in Table 2. From this signal ratio P_{XRF}(S) and the conversion factor F of Table 1, the element content M_{XRF} is calculated by the equation (2).

M_{XRF}=F·P_{XRF}(S) (2)

TABLE 2
Content of Element M(ICP) in Hair of Test Subject (Direct
Fluorescent X-ray Spectroscopy of Hair)

| | | Mineral | | | |
|---|---|---|---|---|---|
| Test | | Calcium | Copper | Zinc | Lead |
| Subject | Average of Conversion Factor | 1300 | 35 | 64 | 21 |
| 1 | Signal Ratio | 0.77 | 0.35 | 1.09 | 0.06 |
| | Content of Element(ppm) | 1001 | 12 | 70 | 1.3 |
| 2 | Signal Ratio | 0.27 | 0.54 | 0.76 | 0.03 |
| | Content of Element(ppm) | 351 | 19 | 49 | 0.6 |
| 3 | Signal Ratio | 0.54 | 0.4 | 1.03 | 0.06 |
| | Content of Element(ppm) | 702 | 14 | 66 | 1.3 |
| 4 | Signal Ratio | 0.29 | 0.61 | 1.13 | 0.04 |
| | Content of Element(ppm) | 377 | 21 | 72 | 0.8 |
| 5 | Signal Ratio | 2.87 | 0.78 | 1.09 | 0.12 |
| | Content of Element(ppm) | 3731 | 27 | 70 | 2.5 |

By the same manner, the element content M_{XRF} can be obtained for other elements. By way of example only, it is possible to analyze iron, magnesium, cobalt, manganese, molybdenum, selenium, iodine, arsenic, mercury, nickel, cesium, and so on.

### Example 2

### Comparison of Test Subject

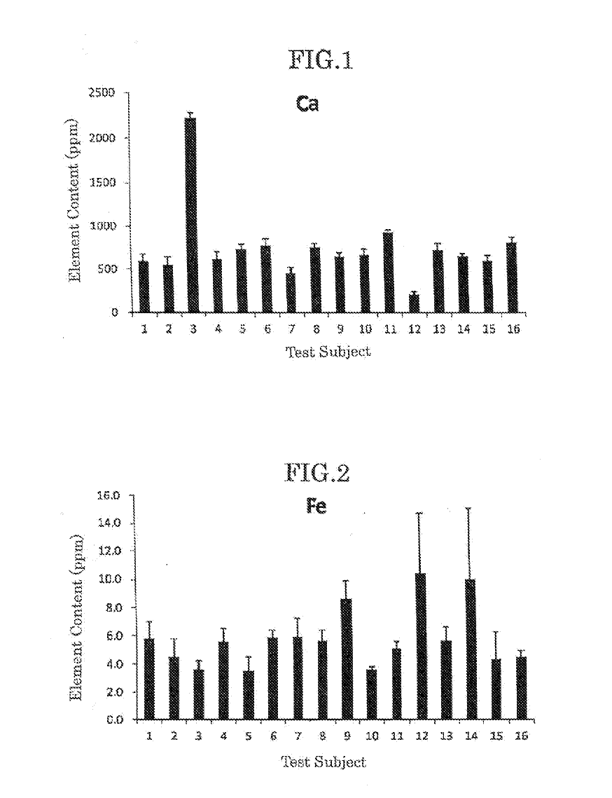

By means of the analytical method of example 1, analysis of calcium, iron, copper and zinc in hair are performed for sixteen test subjects exclusive of the test subject of example 1. FIGS. 1-4 are the bar graphs showing the result of hair analysis for sixteen test subjects.

FIG. 1 is the analytical result of calcium. About the hair of test subject No. 3, the calcium concentration (content) higher than other test subjects is seen (2200 ppm). This is the typical “calcium paradox”, and the calcium concentration in cells rises up in the human body that calcium is short, so that the calcium concentration in hair rises, too. That is to say, the test subject No. 3 is in the lack state of calcium.

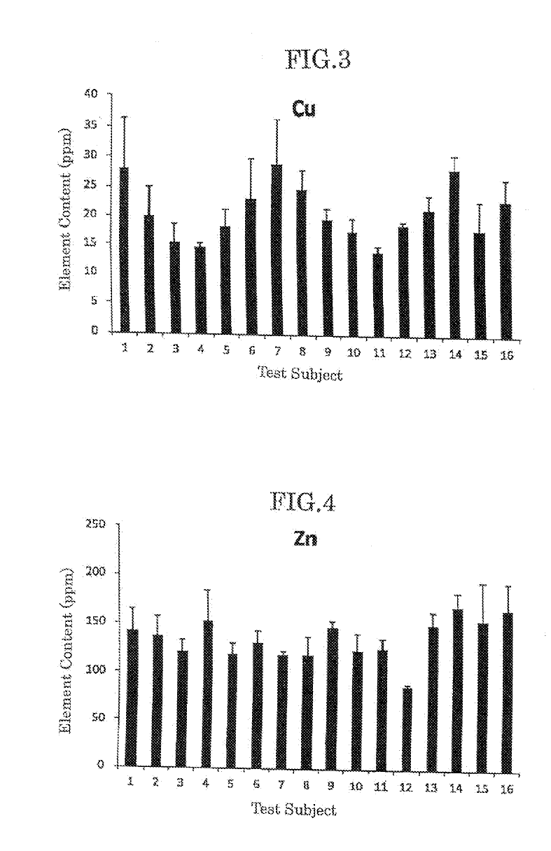

FIG. 2 is the analytical result of iron. About the test subjects Nos. 3, 5 and 10, the lack of iron is seen. FIG. 3 is the analytical result of copper, and for all test subjects, the lack of copper is not seen. FIG. 4 is the analytical result of zinc, and the lack of zinc is seen for the test subject No. 12.

### Example 3

### ICP-MS Analysis of the Dissolution Liquid of Hair

[1] Hair as reference: from each of three persons of the reference test subject in the example 1, the reference hairs of 0.2 g from the root portion (about 150 hairs of 3 cm in length from its root) are collected. After weighing the reference hair (about 0.2 g) of each of three persons, it is dissolved in concentrated nitric acid of about 3 mL and it is assumed 10 mL by adding water.

About this solution, the fluorescence X-ray analysis and ICP-MS analysis are done. The method of ICP-MS analysis is the same as ICP-MS analysis of reference hair in example 1.

In the fluorescence X-ray analysis, the solution of reference hair (1-10 μL) is dropped on the center of slide glass, and after this solution is dried, the residual substance is analyzed. The slide glass is set in the fluorescence X-ray analysis device and the X-rays originated from Mo-Kα or Cu-Kα are irradiated to the residual, so that the fluorescence X-ray spectrum is obtained by measuring the fluorescence X-ray generated from it. This spectrum is normalized so as to assume the peak area of sulfur “1”, and the peak area of each mineral element is measured. This normalized peak area is assumed the reference signal ratio P_{0.XRF}(S). These reference signal ratio P_{0.XRF}(S) and the reference element content M_{0.ICP} measured by the same method as example 1 are summarized as Table 3.

TABLE 3
Determination of Conversion Factor F of Reference Hair by
Analysis of Solution

| Reference | | Mineral | | | |
|---|---|---|---|---|---|
| Test Subject | | Calcium | Copper | Zinc | Lead |
| 1 | Reference Signal Ratio | 0.79 | 0.37 | 1.13 | 0.09 |
| | Reference Content of | 929 | 10 | 79.6 | 1.2 |
| | Element (ppm) | | | | |
| | Conversion Factor (ppm) | 1176 | 27.0 | 70.4 | 13 |
| 2 | Reference Signal Ratio | 0.23 | 0.55 | 0.73 | 0.06 |
| | Reference Content of | 342 | 23.5 | 34.2 | 0.7 |
| | Element (ppm) | | | | |
| | Conversion Factor (ppm) | 1487 | 42.7 | 46.8 | 12 |
| 3 | Reference Signal Ratio | 0.54 | 0.4 | 1.03 | 0.06 |
| | Reference Content of | 757 | 13.8 | 74.9 | 1.3 |
| | Element (ppm) | | | | |
| | Conversion Factor (ppm) | 1402 | 34.5 | 73 | 22 |
| | Average of Conversion | 1355 | 34.8 | 63.3 | 16 |
| | Factor | | | | |

In example 1, the fluorescence X-ray analysis is done by irradiating the X-rays to hair in itself, but in the present example, by making dissolve the hairs and irradiating the X-rays to the solution, the fluorescence X-ray analysis is performed. The concentration of a mineral in a hair is naturally different from the concentration of the mineral in the solution. However, even if a hair is dissolved as a water solution, the ratio of mineral concentration to sulfur concentration does not vary. Therefore, the reference signal ratio P_{0.XRF}(S) in the present example is the same as the reference signal ratio P_{0.XRF}(S) of example 1 within the error range. With regard to each of minerals targeted in Table 3, the standard value of reference signal ratio P_{0.XRF}(S) and the standard value of reference element content M_{0.ICP} for said three persons are calculated, and the conversion factor F is calculated by the equation (1).

[2] Hair of test subject: from each of five persons of the test subject in the example 1, about 150 hairs of the forehead of 3 cm in length from its root portion (about 0.2 g) are collected. After weighing about 0.2 g of the hairs from each of five persons, it is dissolved in concentrated nitric acid of about 3 mL and it is assumed 10 mL by adding water. About this solution, the fluorescence X-ray analysis and ICP-MS analysis are done. The method of ICP-MS analysis is the same as ICP-MS analysis of hair in example 1.

In the fluorescence X-ray analysis, the solution of hair (10 μL) is dropped on the center of slide glass in the same way of the reference hair analysis, and after this solution is dried, the residual substance is analyzed. The slide glass is set in the fluorescence X-ray analysis device and the X-rays originated from Mo-Kα or Cu-Kα are irradiated to the residual substance, so that the fluorescence X-ray spectrum is obtained by measuring the fluorescence X-ray generated from it. This spectrum is normalized so as to assume the peak area of sulfur “1”, and the peak area of each mineral element is measured. This normalized peak area is assumed the signal ratio P_{XRF}(S). The signal ratio P_{0.XRF}(S) of hair of the test subject are summarized as Table 4.

TABLE 4
Content of Metal M(ICP) in Hair of Test Subject
(Fluorescent X-ray Spectroscopy of Hair Solution)

| | | Mineral | | | |
|---|---|---|---|---|---|
| Test | | Calcium | Copper | Zinc | Lead |
| Subject | Average of Conversion Factor | 1355 | 34.8 | 63.3 | 16 |
| 1 | Signal Ratio | 0.75 | 0.36 | 1.1 | 0.08 |
| | Content of Element(ppm) | 1016 | 12.5 | 69.6 | 1.3 |
| 2 | Signal Ratio | 0.26 | 0.56 | 0.74 | 0.05 |
| | Content of Element(ppm) | 352 | 19.5 | 46.8 | 0.8 |
| 3 | Signal Ratio | 0.55 | 0.39 | 1.05 | 0.07 |
| | Content of Element(ppm) | 745 | 13.6 | 66.5 | 1.1 |
| 4 | Signal Ratio | 0.32 | 0.61 | 1.14 | 0.06 |
| | Content of Element(ppm) | 434 | 21.2 | 72.2 | 1.0 |
| 5 | Signal Ratio | 2.89 | 0.81 | 1.06 | 0.14 |
| | Content of Element(ppm) | 3916 | 28.2 | 67.1 | 2.2 |

In the case of solution in which hairs are dissolved, the mineral concentration varies in comparison with the concentration of hair before dissolution, but the ratio of mineral concentration to sulfur concentration does not vary. Therefore, the signal ratio P_{XRF}(S) in the present example is the same as the signal ratio P_{XRF}(S) of example 1 within the error range. From this signal ratio P_{XFR}(S) and the conversion factor F of Table 3, the element content M_{XRF} is calculated by the equation (2). The element content M_{XRF} in the present example shows the good agreement with the element content M_{XRF} in the example 1. Therefore, in the present example, the trouble to make dissolve the hairs is taken, but it is possible to derive the concentration of mineral element in the whole hair more surely

### Example 4

### Calibration Curve by Fluorescence X-Ray Analysis

With respect to iron, copper, zinc, arsenic, cadmium, mercury, lead, titanium and cesium as minerals, each mineral solutions are prepared in the concentration range of 0.10 mg/mL-2.0 mg/mL. In addition, for all normal solutions, thiourea is prepared as 20 mg/mL. The concentration of sulfur becomes 8.4 mg/mL.

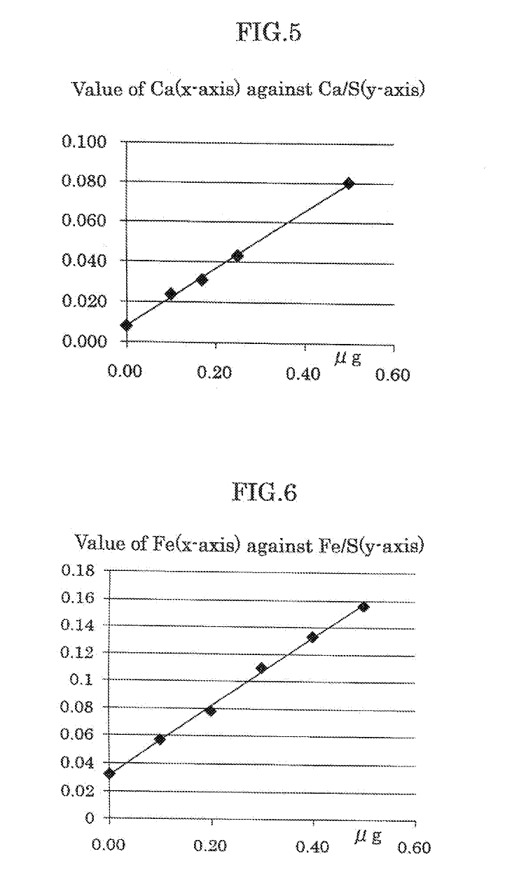

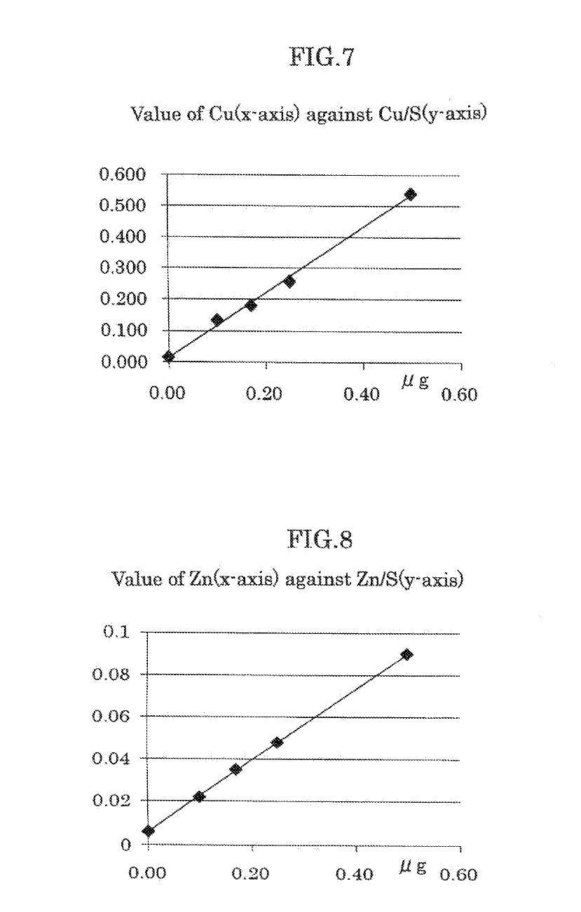

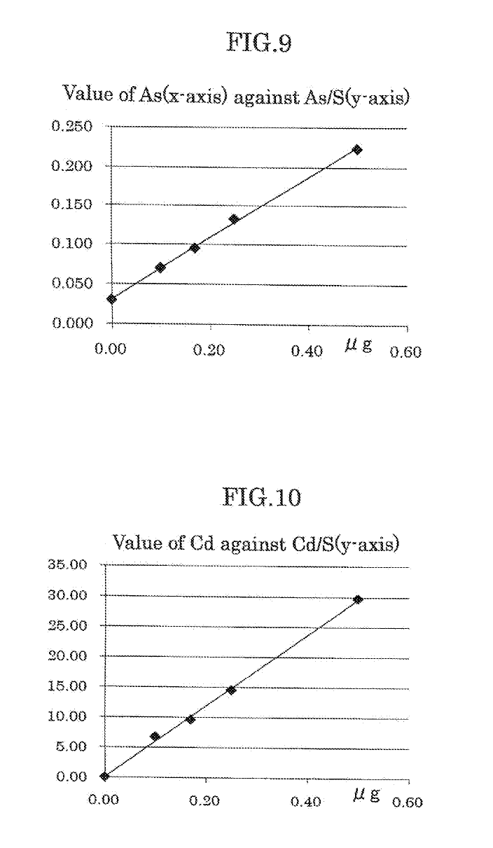

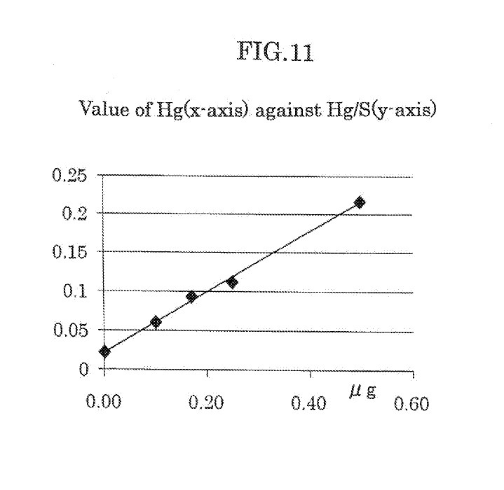

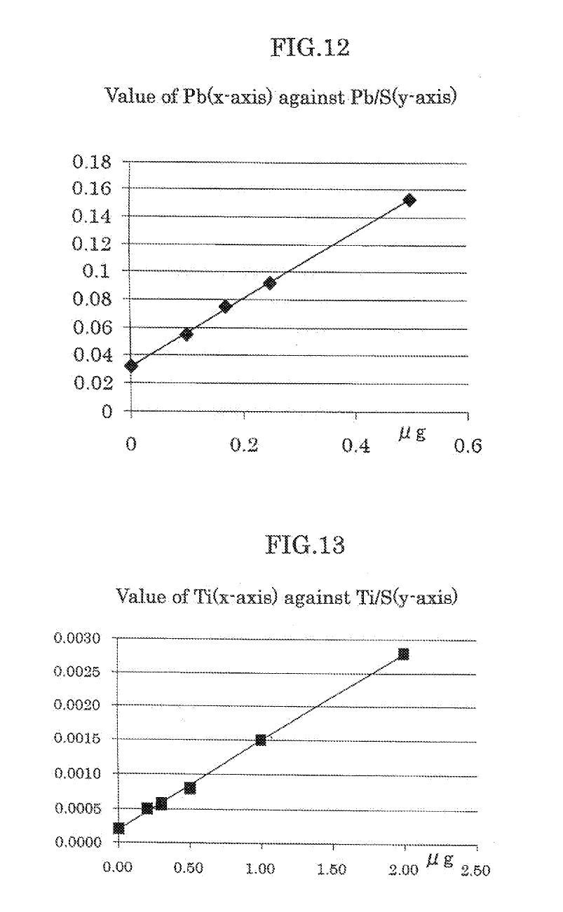

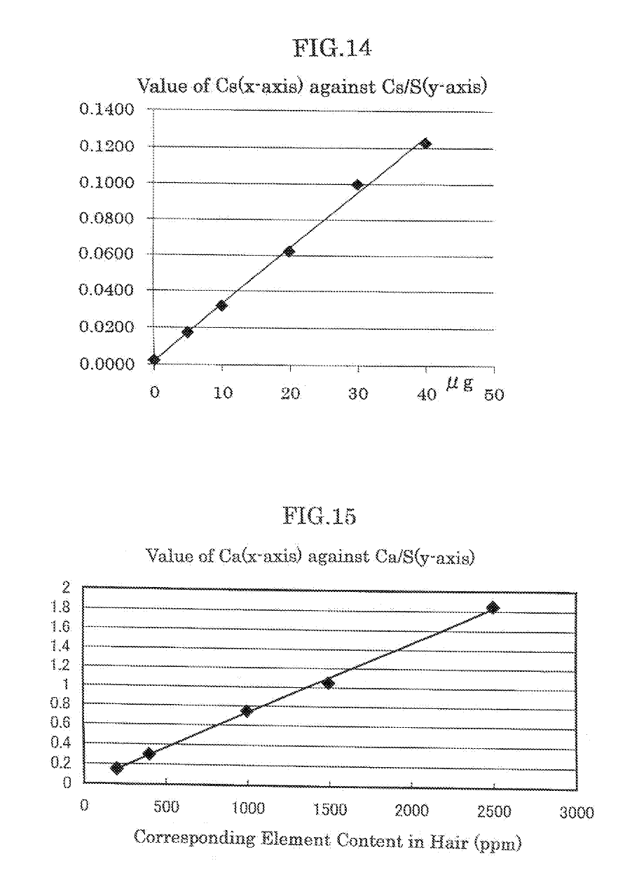

The 1-10 μL for each of these normal solutions are dropped on the slide glass and dried, so that the signal ratio P_{XRF}(S) is measured by the fluorescence X-ray analysis. In a graph, the calibration curve of the signal ratio P_{XRF}(S) to the mass M of mineral dropped is obtained. These calibration curves are illustrated in FIGS. 5-14. In addition, the intercept b and the slope m of these calibration curves are summarized in Table 5. For all calibration curves of minerals, the good linearity is ensured.

TABLE 5
Calibration Curve Data at Mineral Normal Solution by
Fluorescent X-ray Spectroscopy

| Mineral | Intercept b | Slope m(/mg) |
|---|---|---|
| Calcium | 0.008 | 0.15 |
| Iron | 0.032 | 0.25 |
| Copper | 0.015 | 1.05 |
| Zinc | 0.006 | 0.17 |
| Boron | 0.03 | 0.4 |
| Cadmium | 0.1 | 59.4 |
| Mercury | 0.022 | 0.39 |
| Lead | 0.032 | 0.24 |
| Titanium | 0.002 | 0.013 |
| Cesium | 0.025 | 0.0031 |

### Example 5

### Determination of Conversion Factor F by Fluorescence X-Ray Analysis

The conversion factor F can be obtained based upon the calibration curve.

In the present example, as mineral metal, only calcium is contrasted.

The concentrations of calcium and sulfur in the normal solution necessary for the calibration are discussed. In example 4, by dissolving 0.2 g of hairs, the water solution of 10 mL (about 10 g) is prepared. The sulfur content in a hair is about 5% (50,000 ppm), and so, the sulfur content in the hair water solution becomes 1/50 (0.2/10) of said content, namely 1,000 ppm. In addition, as the calcium content in a hair, around 200-2500 ppm are expected. That is to say, in said hair water solution, 4-50 ppm that are 1/50 of these contents are expected. Therefore, in the normal solution, calcium of 0.004-0.05 mg/mL and sulfur of 1 mg/mL are necessary.

The normal solutions with different concentration (0.004, 0.008, 0.02, 0.03, 0.05 mg/mL) are prepared. These normal solutions are equivalent to the cases that the calcium contents in said hair water solution are 200, 400, 1000, 1500, 2500 ppm, respectively. In these normal solutions, thiouric acid of 2.4 mg/mL is contained, and the sulfur content becomes 1.0 mg/mL, so that it is equivalent to the case that the sulfur content in said hair water solution is 5%.

These calcium normal solutions are dropped on the slide glass by 1-10 μL and they are dried. The residual substance is analyzed with the fluorescence X-ray analysis device, and the reference signal ratio P_{0.XRF}(S) is obtained. This reference signal ratio is taken as y-axis, while by performing 50 times of the calcium content in the normal solution, the amount transformed to the calcium content in the hair water solution is taken as x-axis, so that the calibration curve is obtained. This calibration curve is shown in FIG. 15.

The intercept b with y-axis in this calibration curve is 0.006 and the slope m becomes 0.000732/ppm. The reciprocal number of this slope is 1,366 ppm, and this value becomes the conversion factor F. The conversion factor F in the present example is well corresponding to the conversion factor F obtained in the examples 1 and 3.

By means of this conversion factor F, the calcium content M_{XRF} is calculated on the basis of the fluorescence X-ray analysis data of the hair water solution in the example 3 and the equation (1). Calcium content M_{XRF} in the hair of test subject 1-5 is summarized in table 6. The element content M_{XRF} corresponds to Table 4 well, and the determination method of the conversion factor F in the present example is testified because of its availability.

TABLE 6
Calcium Metal Content M(ICP) in Hair of Test Subject
(Calculation using Conversion Factor by Calcium Normal Solution)

| Test | Conversion Factor from | Calcium |
|---|---|---|
| Subject | Calibration Curve | 1366 |
| 1 | Signal Ratio | 0.75 |
| | Element Content(ppm) | 1025 |
| 2 | Signal Ratio | 0.26 |
| | Element Content(ppm) | 355 |
| 3 | Signal Ratio | 0.55 |
| | Element Content(ppm) | 751 |
| 4 | Signal Ratio | 0.32 |
| | Element Content(ppm) | 437 |
| 5 | Signal Ratio | 2.89 |
| | Element Content(ppm) | 3948 |

It is needless to say that the present invention is not limited to the above-described examples and contains various kinds of examples in the range not deviating from technical idea of the present invention.

### INDUSTRIAL APPLICABILITY

According to the examination method of element in the living body sample by means of the fluorescence X-ray analysis device of the present invention, the content of essential element such as mineral element is examined simply and surely, and the health care about intake of these essential element is enabled. In addition, in regard to the internal pollution by taking of the toxic element into the human body, it becomes possible to examine simply the effect for body by use of the living body sample, and in regard to the detoxification effect of the toxic element taken in, it is possible to evaluate the effect of various foods and supplements non-destructively and simply.

1. A method for examination of element in living body comprising the steps of measuring a signal ratio P_{XRF}(S) of a mineral element contained in a hair of a test subject to sulfur contained in said hair by a fluorescence X-ray analysis, and in order to calculate an element content M_{XRF} of said mineral element from said signal ratio P_{XRF}(S), multiplying said signal ratio P_{XRF}(S) by a conversion factor F used in the calculation.

2. The method for examination of element in living body according to claim 1, wherein said conversion factor F is derived from the steps of measuring a reference signal ratio P_{0.XRF}(S) of said mineral element contained in a reference hair collected from a person exclusive of said test subject to said sulfur contained in said reference hair by said fluorescence X-ray analysis, measuring a reference element content M_{0.ICP} of said mineral element by an inductivity coupled plasma mass spectrometry, and calculating said conversion factor F from a formula of F=M_{0.ICP}/P_{0.XRF}(S).

3. The method for examination of element in living body according to claim 1 or 2, wherein said fluorescence X-ray analysis is performed by detecting fluorescence X-ray occurring through irradiating of X-rays to said hair.

4. The method for examination of element in living body according to claim 1 or 2, wherein said fluorescence X-ray analysis is performed by the steps of dissolving said hair in a solvent and detecting fluorescence X-ray occurring through irradiating of X-rays to said solution.
